(19) United States
(12) Patent Application Publication
(10) Pub. No.: US 2014/0310126 A1
(43) Pub. Date: Oct. 16, 2014

(54) System and Method for Performing a Wager Using a Mobile Phone

(71) Applicant: Amaya Gaming Group, Inc., Pointe-Claire (CA)

(72) Inventor: David Baazov, Dollard-des-Ormeaux (CA)

(21) Appl. No.: 14/358,699

(22) PCT Filed: Nov. 19, 2012
(86) PCT No.: PCT/CA2012/001090

§ 371 Date: May 15, 2014

Related U.S. Application Data
(60) Provisional application No. 61/560,871, filed on Nov. 17, 2011.

(51) Int. Cl. G06Q 20/32; G06Q 30/06

(52) U.S. Cl. CPC G06Q 20/3224; G06Q 30/0607
USPC 705/26.25

(57) ABSTRACT

A system and method for performing lottery ticket purchase with a mobile phone include receiving an SMS message sent by a user using the mobile phone, the SMS message including data associated with the lottery ticket to purchase; obtaining data associated with a position of the mobile phone, the data associated with a position of the mobile phone comprising an identification of a cell tower receiving the SMS message; determining if the user of said mobile phone is allowed to purchase the lottery ticket, the determining including checking if the identification of a cell tower receiving the SMS message matches one of a list of allowed cell towers and if the user is registered and performing the purchase if the identification of a cell tower receiving the SMS message matches one of a list of allowed cell towers.

### CROSS-REFERENCE TO RELATED APPLICATIONS

This patent application claims priority of U.S. Provisional Patent Application No. 61/560,871, filed on Nov. 17, 2011, entitled “System and Method for Performing a Purchase of a Lottery Ticket Using a Mobile Phone,” the specification of which is herein incorporated by reference.

### FIELD OF THE INVENTION

The invention relates to SMS lottery systems. More precisely, the invention pertains to a system and method for performing a wager using a mobile phone.

### BACKGROUND

Lottery tickets have to be purchased by players who are geographically within a given jurisdiction in order to comply with applicable laws.

Performing a wager can therefore be very complicated to implement when it is made using a mobile phone, since the requirement for ensuring that the user is within the given jurisdiction has still to be met.

In some instances, the task of locating a smartphone is easy since the mobile phone is provided with a global position system (GPS) device. The task of locating precisely the smartphone can be cumbersome when the smartphone or a mobile phone is not provided with any positioning system. This can be also complicated in the case where the global position system (GPS) device is not able to provide a position such as, for instance, if the user is inside a building.

There is a need for a method and system that will overcome at least one of the above-identified drawbacks.

Features of the invention will be apparent from review of the disclosure, drawings and description of the invention below.

### BRIEF SUMMARY

According to one aspect, there is disclosed a method for performing a wager using a mobile phone, the method comprising receiving a request for performing a wager using a mobile phone; obtaining an identification of a cell tower receiving the request for performing the wager; determining if a user of said mobile phone is allowed to perform the wager, the determining comprising checking if the identification of the cell tower receiving the request for performing the wager matches one of a list of allowed cell towers and checking if the user is registered; and performing the wager if the identification of a cell tower receiving the request for performing the wager matches one of a list of allowed cell towers and if the user is registered.

In accordance with one embodiment, the mobile phone is a smartphone and the request for performing a wager is generated by an application running on the smartphone.

In accordance with another embodiment, the method further comprises the user registering on the application.

In accordance with one embodiment, the method further comprises the user registering on a web page.

In accordance with one embodiment, the user is not registered and the method further comprises inviting the user to register.

In accordance with one embodiment, the identification of a cell tower comprises longitude and latitude coordinates of the cell tower and the checking if the identification of a cell tower receiving the request for performing a wager matches one of a list of allowed cell towers is performed by comparing the longitude and latitude coordinates of the cell tower receiving the request for performing a wager with acceptable coordinates.

In accordance with another embodiment, the performing of a wager comprises performing a purchase of a lottery ticket, further wherein the request for performing a wager comprises an SMS message provided by the mobile phone.

In accordance with another embodiment, the obtaining of an identification of a cell tower receiving the request for performing the wager comprises providing a number corresponding to the mobile generating the phone request for performing a wager to a geolocalization server and receiving from the geolocalization server the identification of a cell tower.

According to a broad aspect, there is disclosed a method for performing a purchase of a lottery ticket using a mobile phone, the method comprising receiving an SMS message sent by a user using the mobile phone, the SMS message comprising data associated with the lottery ticket to purchase; obtaining an identification of a cell tower receiving the SMS message; determining if the user of said mobile phone is allowed to purchase the lottery ticket, the determining comprising checking if the identification of the cell tower receiving the SMS message matches one of a list of allowed cell towers and checking if the user is registered and performing the purchase if the identification of a cell tower receiving the SMS message matches one of a list of allowed cell towers and if the user is registered.

According to another broad aspect, there is disclosed a method for generating a list of allowed cell towers for a given jurisdiction to be used in a system for performing a wager using a mobile phone, the method comprising obtaining for each given cell tower of a plurality of cell towers an indication of the given cell tower and corresponding geographic coordinates of the given cell tower; obtaining an indication of a size of an uncertainty zone; obtaining a list of a plurality of geographic coordinates defining a border between two jurisdictions; determining for each given cell tower of the plurality of cell towers if the given cell tower is in the uncertainty zone using the corresponding geographic coordinates of the given cell tower, the indication of the size of the uncertainty zone and the list of a plurality of geographic coordinates defining the border between the two jurisdictions and; if the given cell tower is not in the uncertainty zone, determining if the given cell tower is in the given jurisdiction; and if the given cell tower is in the given jurisdiction, providing a corresponding indication of the given cell tower.

According to a broad aspect, there is disclosed a computer-readable storage medium for storing computer-executable instructions which when executed cause a computing device to perform a method for generating a list of allowed cell towers for a given jurisdiction to be used in a system for performing a wager using a mobile phone, the method comprising obtaining for each given cell tower of a plurality of cell towers an indication of the given cell tower and corresponding geographic coordinates of the given cell tower; obtaining an indication of a size of an uncertainty zone; obtaining a list of a plurality of geographic coordinates defining a border between two jurisdictions; determining for each given cell tower of the plurality of cell towers if the given cell tower is in the uncertainty zone using the corresponding geographic coordinates of the given cell tower, the indication of the size of the uncertainty zone and the list of a plurality of geographic coordinates defining the border between the two jurisdictions and; if the given cell tower is not in the uncertainty zone, determining if the given cell tower is in the given jurisdiction; and if the given cell tower is in the given jurisdiction, providing a corresponding indication of the given cell tower.

In accordance with one embodiment, the geographic coordinates comprise longitude and latitude coordinates.

According to a broad aspect, there is disclosed a system for performing a wager using a mobile phone, the system comprising a display device; a central processing unit; a first communication port operatively connected to the mobile phone; a second communication port operatively connected to a unit providing an identification of a cell tower used by the mobile phone; a memory comprising a database for storing a list of allowed cell towers and an application for performing a wager, the application for performing a wager comprising instructions for receiving via the first communication port a request for performing a wager sent by a user using the mobile phone, the request for performing a wager comprising data associated with the wager to perform; instructions for obtaining via the second communication port an identification of a cell tower receiving the request for performing a wager via the communication port; instructions for determining if the user of the mobile phone is allowed to perform the wager, the determining comprising checking if the identification of the cell tower receiving the request for performing the wager matches one of a list of allowed cell towers and checking if the user is registered; instructions for performing the purchase if the identification of a cell tower receiving the request for performing a wager matches is in the list of allowed cell towers and if the user is registered.

According to a broad aspect, there is disclosed a computer-readable storage medium for storing computer-executable instructions which when executed cause a computing device to perform a method for performing a wager using a mobile phone, the method comprising receiving a request for performing a wager sent using the mobile phone; obtaining an identification of a cell tower receiving the request for performing a wager; determining if the user of the mobile phone is allowed to purchase the lottery ticket, the determining comprising checking if the identification of the cell tower receiving the request for performing a wager matches one of a list of allowed cell towers and; checking if the user is registered and performing the wager if the identification of a cell tower receiving the request for performing a wager matches one of a list of allowed cell towers and if the user is registered.

An advantage of the method disclosed is that it enables to readily check if a user should be allowed to purchase a lottery ticket using a mobile phone which does not have positioning means, such as a GPS.

An advantage of the method disclosed herein is that it enables SMS lottery operators to be certain that their lotteries are operated within the geographical boundaries of a specific jurisdiction and this in compliance with the laws of the jurisdiction's regulatory gaming authority.

Another advantage is that the method disclosed uses a conservative approach to find out if a mobile phone is within a proper jurisdiction which is desirable for a lottery application.

### BRIEF DESCRIPTION OF THE DRAWINGS

In order that the invention may be readily understood, embodiments of the invention are illustrated by way of example in the accompanying drawings.

FIG. 1 is a diagram which shows an example of a border between two jurisdictions. A plurality of cell towers is provided on each side of the border.

FIG. 2 is a flowchart which shows an embodiment of a method for performing a wager using a mobile phone. FIG. 3 is a flowchart which shows an embodiment of a method for performing a method for performing a wager using a mobile phone.

FIG. 4 is a block diagram which shows an embodiment of a system for performing a purchase of a lottery ticket using a mobile phone.

FIG. 5 is a flowchart which shows an embodiment of a method for generating a list of allowed cell towers for a given jurisdiction to be used in a system for performing a wager using a mobile phone

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

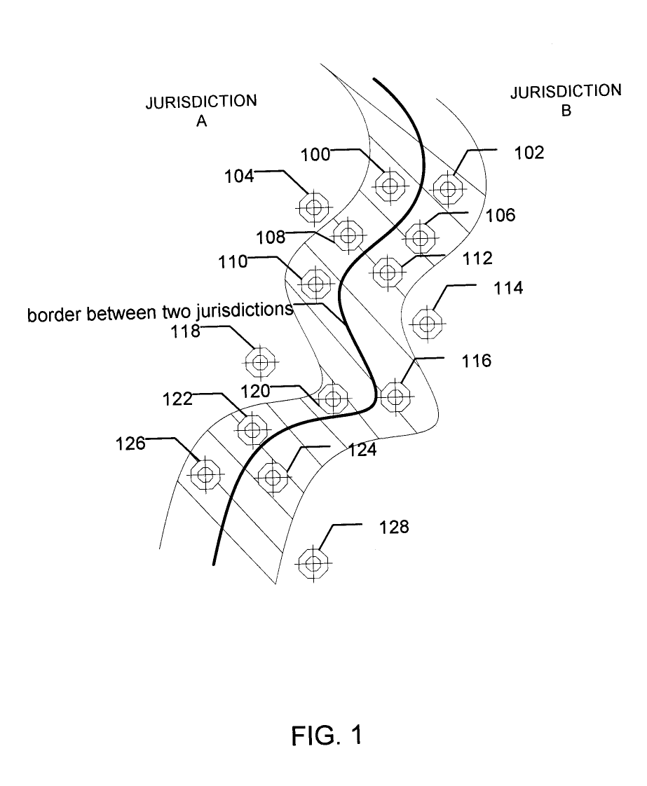

Now referring to FIG. 1, there is shown an example of a border separating two jurisdictions, namely jurisdiction A and jurisdiction B.

It will be appreciated that each jurisdiction is characterized by its own regulations pertaining to gaming. The skilled addressee will appreciate that a jurisdiction may therefore be a country, a state, a province, a zone defined by a given native tribe, or the like.

Still referring to FIG. 1, it will be appreciated that a plurality of cell towers is provided along the border in each of the two jurisdictions. Each of the plurality of cell towers may be used to communicate with a mobile phone. The plurality of cell towers comprises for instance a first cell tower 100, a second cell tower 102, a third cell tower 104, a fourth cell tower 106, a fifth cell tower 108, a sixth cell tower 110, a seventh cell tower 112, a eighth cell tower 114, a ninth cell tower 116, a tenth cell tower 118, a twelfth cell tower 120, a thirteenth cell tower 122, a fourteenth cell tower 124, a fifteenth cell tower 126 and a sixteenth cell tower 128.

It has been contemplated by the inventor that there exists an uncertainty zone comprising a plurality of cell towers in which the probability of having a signal received by a cell towers on a first side while the mobile phone transmitting the signal is on the other side of the border is high.

The skilled addressee will appreciate that while the example disclosed below relates to sending an SMS, it should be understood by the skilled addressee that more generally any communication signal transmitted between the mobile phone and the cell tower could be used as an example.

In one embodiment, this uncertainty zone extends from about 2-3 km from each side of the border. The skilled addressee will appreciate that the size of the uncertainty zone depends on various parameters such as a phone range to the cell tower.

In the embodiment disclosed in FIG. 1, the uncertainty zone comprises the first cell tower 100, the second cell tower 102, the fourth cell tower 106, the fifth cell tower 108, the sixth cell tower 110, the seventh cell tower 112, the ninth cell tower 116, the twelfth cell tower 120, the thirteenth cell tower 122, the fourteenth cell tower 124 and the fifteenth cell tower 126.

Outside the uncertainty zone and, for instance, in the case of an SMS received by one of the third cell tower 104 and the tenth cell tower 118, it can be readily determined that the SMS was sent by a mobile phone located in the jurisdiction A. In the case of an SMS received by one of the eighth cell tower 114 or the sixteenth cell tower 128, it can be readily determined that this SMS was sent by a mobile phone located in the jurisdiction B.

It becomes therefore possible to determine a list of cell towers located in a first jurisdiction for which the uncertainty of receiving an SMS originating from a cell phone located in the second jurisdiction is very low. By checking if an SMS has been received by anyone of those cell towers, it becomes possible to make sure a user is really in a determined jurisdiction which is of great advantage for a gaming application.

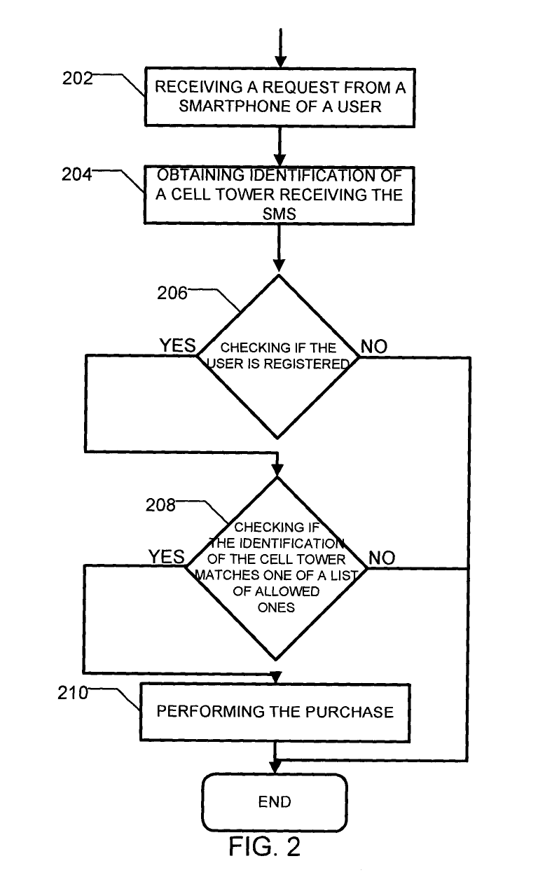

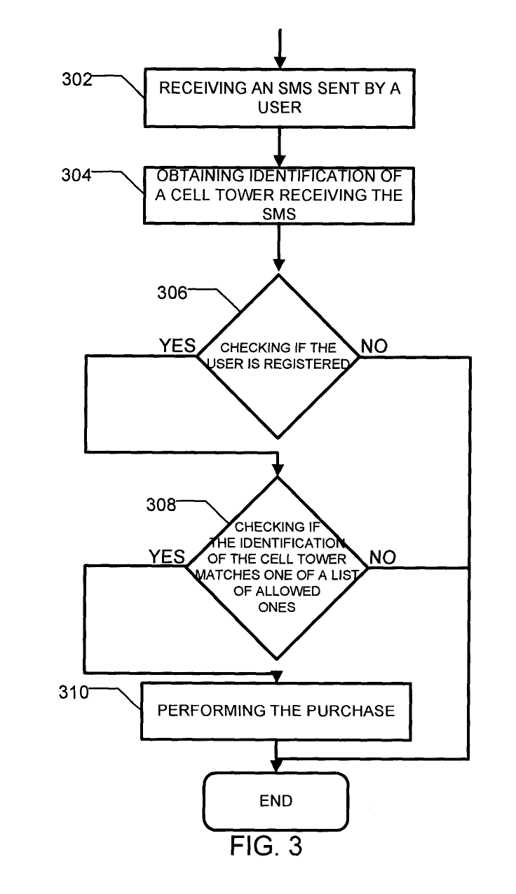

Now referring to FIG. 2, there is shown an embodiment of a method for performing a method for performing a wager using a mobile phone.

According to processing step 202, a request for performing a wager using a mobile phone is received.

It will be appreciated that the request for performing a wager may be provided according to various embodiments.

In one embodiment, the request for performing a wager is provided by an application running on the mobile phone. In another embodiment disclosed in FIG. 3, the request comprises an SMS message provided by a user of the mobile phone.

It will be appreciated that the request may comprise various elements which depend on the application running on the mobile phone. In particular the request may comprise an indication of a user handling the mobile phone and running the application.

The request may further comprise information related to the wager such as for instance the type of wager, the amount wagered and player information.

According to processing step 204, an identification of a cell tower receiving the request for performing a wager is obtained. It will be appreciated by the skilled addressee that the identification of a cell tower receiving the request for performing a wager may be obtained according to various embodiments.

In one embodiment, the identification of the cell tower is obtained using a geolocalization server. More precisely, a number of a phone number sending an request for performing a wager is provided in a request to the geolocalization server. In return, the geolocalization server provides latitude and longitude coordinates of the cell tower which received the request for performing a wager.

According to processing step 206, a check is performed in order to determine if the user is registered.

It will be appreciated that the check to find out if the user is registered is performed in one embodiment by using the phone number of the cell phone and checking it against a database of pre-registered users.

In fact, it will be appreciated that the pre-registering may be performed according to various embodiments. For instance, the pre-registering may be performed via a website by creating an account in which an authentication/validation is performed using at least one of a driver's license, a social security number, a passport, etc. The skilled addressee will appreciate that various alternative embodiments may be provided.

Alternatively, the pre-registering may be performed in the application running on the mobile phone and which provides the request for performing a wager.

The skilled addressee will therefore appreciate that the user may therefore be either registered beforehand or may register on the fly while performing the request.

Accordingly and in one embodiment, the user may be invited to register if the user is not registered.

The skilled addressee will appreciate that the purpose of performing the registration is to make sure the user is of legal age and consents to playing, an indication that the player has an amount of funds in its account sufficient for performing the wager.

In the case where the user is not registered, the purchase is not performed and in accordance with processing step 212, the user is invited to register.

In the case where the user is registered and according to processing step 208, a check is performed in order to determine if the identification of the cell tower receiving the request for performing a wager matches one of a list of allowed cell towers.

It should be understood by the skilled addressee that processing step 208 may be alternatively performed prior processing step 206.

It will be appreciated that in one embodiment, the check is performed by ensuring that the latitude and longitude coordinates are not comprised in the uncertainty zone and are therefore acceptable.

In the case where the identification of the cell tower receiving the request for performing a wager matches one of a list of allowed cell towers and according to processing step 210, the purchase is performed.

In the case where the identification of the cell tower receiving the request for performing a wager matches one of a list of allowed cell towers the purchase is performed.

Now referring to FIG. 3, there is shown an embodiment of a method for performing a purchase of a lottery ticket using a mobile phone. In this embodiment, the wager is performed using an SMS message send by the user of the mobile phone. This may be used in the case where the mobile phone does not have the technical capabilities of running a gaming application.

According to processing step 302, an SMS message sent by a user using the mobile phone is received. The SMS message comprises data associated with the lottery ticket to purchase. It will be appreciated that the data associated with the lottery ticket to purchase may be of various types.

In one embodiment, the data associated with the lottery ticket to purchase comprises a given keyword. It will be appreciated that the given keyword is indicative of a lottery ticket to buy.

According to processing step 304, an identification of a cell tower receiving the SMS message is obtained. It will be appreciated by the skilled addressee that the identification of a cell tower receiving the SMS message may be obtained according to various embodiments.

In one embodiment, the identification of the cell tower is obtained using a geolocalization server. More precisely, a number of a phone number sending an SMS message is provided in a request to the geolocalization server. In return, the geolocalization server provides latitude and longitude coordinates of the cell tower which received the SMS message.

According to processing step 306, a check is performed in order to determine if the user is registered.

It will be appreciated that the check to find out if the user is registered is performed by using the phone number of the cell phone and checking it against a database of pre-registered users.

It will be appreciated that the pre-registering may be performed according to various embodiments. For instance, the pre-registering may be performed via a website by creating an account in which an authentication/validation is performed using at least one of a driver's license, a social security number, a passport, etc. The skilled addressee will appreciate that various alternative embodiments may be provided.

In the case where the user is not registered, the purchase is not performed and in accordance with processing step 312, the user is invited to register.

In the case where the user is registered and according to processing step 308, a check is performed in order to determine if the identification of the cell tower receiving the SMS message matches one of a list of allowed cell towers.

It will be appreciated that in one embodiment, the check is performed by ensuring that the latitude and longitude coordinates are not comprised in the uncertainty zone and are therefore acceptable.

In the case where the identification of the cell tower receiving the SMS message matches one of a list of allowed cell towers and according to processing step 310, the purchase is performed.

In the case where the identification of the cell tower receiving the SMS message matches one of a list of allowed cell towers the purchase is performed.

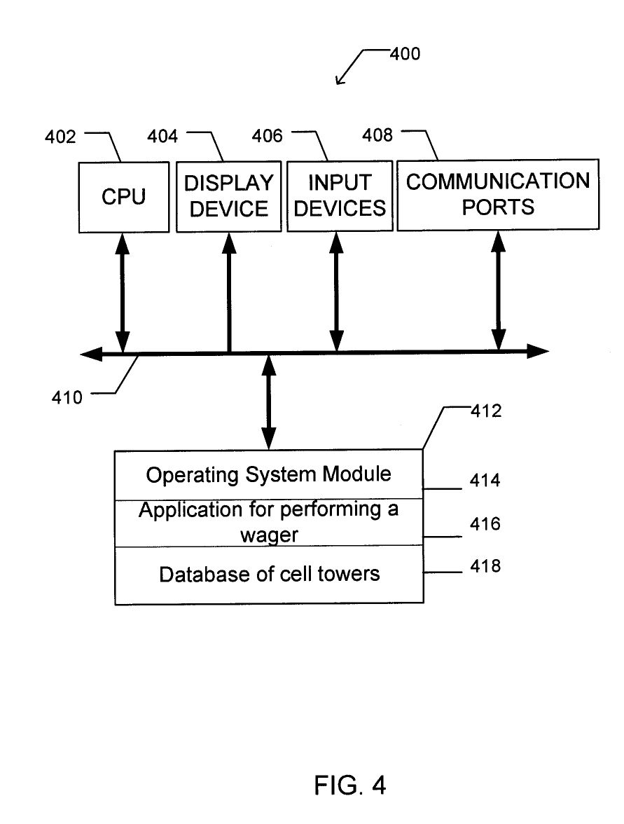

Now referring to FIG. 4, there is shown an embodiment of a system for performing a wager using a mobile phone.

In this embodiment, the system 400 comprises a central processing unit (CPU) 402, a display device 404, input devices 406, communication ports 408, a data bus 410, and a memory 412.

It will be further appreciated that the display device 404 may be of various types.

Still in one embodiment, the input devices 406 comprise a keyboard and a mouse.

It will be appreciated that the communication ports 408 are used for communicating with a cellular network. More precisely, the communication ports 408 may comprise a first communication port operatively connected to the mobile phone. The communication port 408 may comprise a second communication port operatively connected to a unit providing an identification of a cell tower used by the mobile phone.

It will be appreciated that the central processing unit (CPU) 402 may be of various types. In fact, it will be appreciated that the system for performing a purchase of a lottery ticket using a mobile phone disclosed herein are typically processing between 60-100 SMS messages per second which are one embodiment of a request for performing a wager. It will be appreciated by the skilled addressee that the specifications of the system for performing a wager may vary greatly from the most basic computer to an advanced server depending on the size jurisdiction in which the system is deployed.

The memory 412 is used for storing data. More precisely and in one embodiment, the memory 412 comprises an operating system module 414, an application for performing a wager 416 and a database of cell towers.

In one embodiment, the operating system module 414 is provided by Microsoe™.

Still in one embodiment, the application for performing a wager 416 comprises instructions for receiving a request for performing a wager sent by a user using the mobile phone, the request for performing a wager comprising data associated with the wager to perform.

The application for performing a wager 416 further comprises instructions for obtaining an identification of a cell tower receiving the request for performing a wager.

The application for performing a wager 416 further comprises instructions for determining if the user of the mobile phone is allowed to perform the wager, the determining comprising checking if the identification of the cell tower receiving the request for performing the wager matches one of a list of allowed cell towers and checking if the user is registered.

The application for performing a wager 416 further comprises instructions for performing the purchase if the identification of a cell tower receiving the request for performing a wager matches is in the list of allowed cell towers and if the user is registered.

The database of cell towers 418 comprises a list of allowed cell towers. It will be appreciated that the list of allowed cell towers may be generated according to various embodiments.

The central processing unit (CPU) 402, the display device 404, the input devices 406, the communication ports 408 and the memory 412 are operatively interconnected via the data bus 410.

It will be appreciated that in one embodiment, transactional data are maintained for a period of 5 years. The transactional data include data, time, mobile number, latitude and longitude for each transaction. Still in one embodiment, the transactional data are stored in a secure location.

Also, it will be appreciated that a computer-readable storage medium may be provided for storing computer-executable instructions. Such computer-executable instructions, when executed, would cause a computing device to perform a method for performing a wager using a mobile phone, the method comprising receiving a request for performing a wager sent using the mobile phone, the request for performing a wager comprising data associated with the lottery ticket to purchase; obtaining an identification of a cell tower receiving the request for performing a wager; determining if the user of the mobile phone is allowed to purchase the lottery ticket, the determining comprising checking if the identification of the cell tower receiving the request for performing a wager matches one of a list of allowed cell towers and checking if the user is registered and performing the wager if the identification of a cell tower receiving the request for performing a wager matches one of a list of allowed cell towers and if the user is registered.

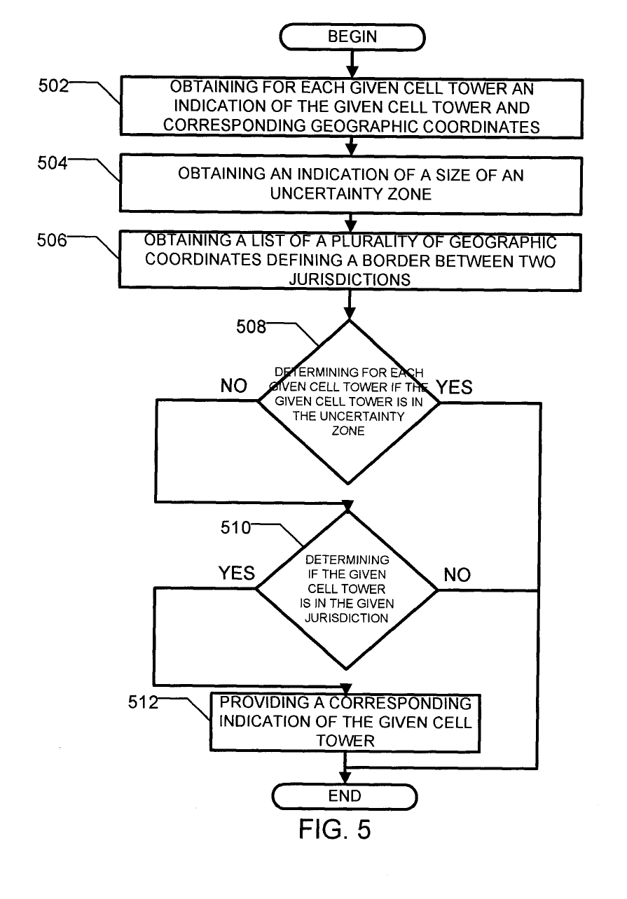

Now referring to FIG. 5, there is shown an embodiment of a method for generating a list of allowed cell towers for a given jurisdiction to be used in a system for performing a wager using a mobile phone. The skilled addressee will appreciate that the method may be used for a plurality of jurisdictions. A list of a plurality of allowed cell towers will be generated, each for a given jurisdiction.

More precisely and according to processing step 502, an indication a given cell tower and corresponding geographic coordinates of the given cell tower is obtained for each of a plurality of cell towers.

It will be appreciated that in one embodiment, the geographic coordinates comprise longitude and latitude coordinates.

It will be appreciated that the indication of a given cell tower and its corresponding coordinates may be provided by various providers which will depend from one jurisdiction to the other.

According to processing step 504, an indication of a size of an uncertainty zone is provided.

It will be appreciated that the indication of a size may be of various types. In one embodiment the size is defined by a width center around a border line.

According to processing step 506, a list of a plurality of geographic coordinates defining a border between two jurisdictions is obtained.

It will be appreciated that the geographic coordinates defining a border between two jurisdiction may be obtained via a website in one embodiment.

According to processing step 508, a test is performed in order to determine if for each given cell tower of the plurality of cell towers, the given cell tower is in the uncertainty zone using the corresponding geographic coordinates of the given cell tower, the indication of the size of the uncertainty zone and the list of a plurality of geographic coordinates defining the border between the two jurisdictions.

In the case where the given cell tower is not in the uncertainty zone and according to processing step 510, a test is performed in order to find out if the given cell tower is in the given jurisdiction.

The skilled addressee will appreciate that since a border is used to separate two different sides, the given cell tower may be in one of the two sides, i.e. in the given jurisdiction or not.

In the case where the given cell tower is in the given jurisdiction and according to processing step 512, a corresponding indication of the given cell tower is provided.

Also, it will be appreciated that a computer-readable storage medium may be provided for storing computer-executable instructions. Such computer-executable instructions, when executed, would cause a computing device to perform a method for generating a list of allowed cell towers for a given jurisdiction to be used in a system for performing a wager using a mobile phone, the method comprising obtaining for each given cell tower of a plurality of cell towers an indication of the given cell tower and corresponding geographic coordinates of the given cell tower; obtaining an indication of a size of an uncertainty zone; obtaining a list of a plurality of geographic coordinates defining a border between two jurisdictions; determining for each given cell tower of the plurality of cell towers if the given cell tower is in the uncertainty zone using the corresponding geographic coordinates of the given cell tower, the indication of the size of the uncertainty zone and the list of a plurality of geographic coordinates defining the border between the two jurisdictions and; if the given cell tower is not in the uncertainty zone, determining if the given cell tower is in the given jurisdiction; and if the given cell tower is in the given jurisdiction, providing a corresponding indication of the given cell tower.
Clause 1. A method for performing a wager using a mobile phone, the method comprising:

receiving a request for performing a wager using a mobile phone;

obtaining an identification of a cell tower receiving the request for performing the wager;

determining if a user of said mobile phone is allowed to perform the wager, the determining comprising checking if the identification of the cell tower receiving the request for performing the wager matches one of a list of allowed cell towers and checking if the user is registered; and

performing the wager if the identification of a cell tower receiving the request for performing the wager matches one of a list of allowed cell towers and if the user is registered.
Clause 2. The method as claimed in clause 1, wherein the mobile phone is a smartphone, further wherein the request for performing a wager is generated by an application running on the smartphone.
Clause 3. The method as claimed in clause 2, further comprising the user registering on the application.
Clause 4. The method as claimed in clause 2, further comprising the user registering on a web page.
Clause 5. The method as claimed in any one of clauses 1 to 2, wherein the user is not registered, further comprising inviting the user to register.
Clause 6. The method as claimed in any one of clauses 1 to 5, wherein the identification of a cell tower comprises longitude and latitude coordinates of the cell tower, further wherein the checking if the identification of a cell tower receiving the request for performing a wager matches one of a list of allowed cell towers is performed by comparing the longitude and latitude coordinates of the cell tower receiving the request for performing a wager with acceptable coordinates.
Clause 7. The method as claimed in clause 1 wherein the performing of a wager comprises performing a purchase of a lottery ticket, further wherein the request for performing a wager comprises an SMS message provided by the mobile phone.
Clause 8. The method as claimed in any one of clauses 1 to 7, wherein the obtaining of an identification of a cell tower receiving the request for performing the wager comprises providing a number corresponding to the mobile generating the phone request for performing a wager to a geolocalization server and receiving from the geolocalization server the identification of a cell tower.
Clause 9. A method for performing a purchase of a lottery ticket using a mobile phone, the method comprising:

receiving an SMS message sent by a user using the mobile phone, the SMS message comprising data associated with the lottery ticket to purchase;

obtaining an identification of a cell tower receiving the SMS message;

determining if the user of said mobile phone is allowed to purchase the lottery ticket, the determining comprising checking if the identification of the cell tower receiving the SMS message matches one of a list of allowed cell towers and checking if the user is registered; and

performing the purchase if the identification of a cell tower receiving the SMS message matches one of a list of allowed cell towers and if the user is registered.
Clause 10. A method for generating a list of allowed cell towers for a given jurisdiction to be used in a system for performing a wager using a mobile phone, the method comprising:

obtaining for each given cell tower of a plurality of cell towers an indication of the given cell tower and corresponding geographic coordinates of the given cell tower;

obtaining an indication of a size of an uncertainty zone;

obtaining a list of a plurality of geographic coordinates defining a border between two jurisdictions;

determining for each given cell tower of the plurality of cell towers if the given cell tower is in the uncertainty zone using the corresponding geographic coordinates of the given cell tower, the indication of the size of the uncertainty zone and the list of a plurality of geographic coordinates defining the border between the two jurisdictions and; if the given cell tower is not in the uncertainty zone,

determining if the given cell tower is in the given jurisdiction; and

if the given cell tower is in the given jurisdiction, providing a corresponding indication of the given cell tower.
Clause 11. A computer-readable storage medium for storing computer-executable instructions which when executed cause a computing device to perform a method for generating a list of allowed cell towers for a given jurisdiction to be used in a system for performing a wager using a mobile phone, the method comprising:

obtaining for each given cell tower of a plurality of cell towers an indication of the given cell tower and corresponding geographic coordinates of the given cell tower;

obtaining an indication of a size of an uncertainty zone;

obtaining a list of a plurality of geographic coordinates defining a border between two jurisdictions;

determining for each given cell tower of the plurality of cell towers if the given cell tower is in the uncertainty zone using the corresponding geographic coordinates of the given cell tower, the indication of the size of the uncertainty zone and the list of a plurality of geographic coordinates defining the border between the two jurisdictions and; if the given cell tower is not in the uncertainty zone,

determining if the given cell tower is in the given jurisdiction; and

if the given cell tower is in the given jurisdiction, providing a corresponding indication of the given cell tower.
Clause 12. The method as claimed in clause 10, wherein the geographic coordinates comprise longitude and latitude coordinates.
Clause 13. A system for performing a wager using a mobile phone, the system comprising:

a display device;

a central processing unit;

a first communication port operatively connected to the mobile phone;

a second communication port operatively connected to a unit providing an identification of a cell tower used by the mobile phone;

a memory comprising a database for storing a list of allowed cell towers and an application for performing a wager, the application for performing a wager comprising:
instructions for receiving via the first communication port a request for performing a wager sent by a user using the mobile phone, the request for performing a wager comprising data associated with the wager to perform;
instructions for obtaining via the second communication port an identification of a cell tower receiving the request for performing a wager via the communication port;
instructions for determining if the user of the mobile phone is allowed to perform the wager, the determining comprising checking if the identification of the cell tower receiving the request for performing the wager matches one of a list of allowed cell towers and checking if the user is registered;
instructions for performing the purchase if the identification of a cell tower receiving the request for performing a wager matches is in the list of allowed cell towers and if the user is registered.
Clause 14. A computer-readable storage medium for storing computer-executable instructions which when executed cause a computing device to perform a method for performing a wager using a mobile phone, the method comprising:

receiving a request for performing a wager sent using the mobile phone; obtaining an identification of a cell tower receiving the request for performing a wager;

determining if the user of the mobile phone is allowed to purchase the lottery ticket, the determining comprising checking if the identification of the cell tower receiving the request for performing a wager matches one of a list of allowed cell towers and;

checking if the user is registered and performing the wager if the identification of a cell tower receiving the request for performing a wager matches one of a list of allowed cell towers and if the user is registered.

1. A method for performing a wager using a mobile phone, the method comprising:
receiving a request for performing a wager using a mobile phone;
obtaining an identification of a cell tower receiving the request for performing the wager;
determining if a user of said mobile phone is allowed to perform the wager, the determining comprising checking if the identification of the cell tower receiving the request for performing the wager matches one of a list of allowed cell towers and checking if the user is registered; and
performing the wager if the identification of a cell tower receiving the request for performing the wager matches one of a list of allowed cell towers and if the user is registered.

2. The method as claimed in claim 1, wherein the mobile phone is a smartphone, further wherein the request for performing a wager is generated by an application running on the smartphone.

3. The method as claimed in claim 2, further comprising the user registering on the application.

4. The method as claimed in claim 2, further comprising the user registering on a web page.

5. The method as claimed in claim 1, wherein the user is not registered, further comprising inviting the user to register.

6. The method as claimed in claim 1, wherein the identification of a cell tower comprises longitude and latitude coordinates of the cell tower, further wherein the checking if the identification of a cell tower receiving the request for performing a wager matches one of a list of allowed cell towers is performed by comparing the longitude and latitude coordinates of the cell tower receiving the request for performing a wager with acceptable coordinates.

7. The method as claimed in claim 1 wherein the performing of a wager comprises performing a purchase of a lottery ticket, further wherein the request for performing a wager comprises an SMS message provided by the mobile phone.

8. The method as claimed in claim 1, wherein the obtaining of an identification of a cell tower receiving the request for performing the wager comprises providing a number corresponding to the mobile generating the phone request for performing a wager to a geolocalization server and receiving from the geolocalization server the identification of a cell tower.

9. A method for performing a purchase of a lottery ticket using a mobile phone, the method comprising:
receiving an SMS message sent by a user using the mobile phone, the SMS message comprising data associated with the lottery ticket to purchase;
obtaining an identification of a cell tower receiving the SMS message;
determining if the user of said mobile phone is allowed to purchase the lottery ticket, the determining comprising checking if the identification of the cell tower receiving the SMS message matches one of a list of allowed cell towers and checking if the user is registered; and
performing the purchase if the identification of a cell tower receiving the SMS message matches one of a list of allowed cell towers and if the user is registered.

10. A method for generating a list of allowed cell towers for a given jurisdiction to be used in a system for performing a wager using a mobile phone, the method comprising;
obtaining for each given cell tower of a plurality of cell towers an indication of the given cell tower and corresponding geographic coordinates of the given cell tower;
obtaining an indication of a size of an uncertainty zone;
obtaining a list of a plurality of geographic coordinates defining a border between two jurisdictions;
determining for each given cell tower of the plurality of cell towers if the given cell tower is in the uncertainty zone using the corresponding geographic coordinates of the given cell tower, the indication of the size of the uncertainty zone and the list of a plurality of geographic coordinates defining the border between the two jurisdictions and; if the given cell tower is not in the uncertainty zone,
determining if the given cell tower is in the given jurisdiction; and
if the given cell tower is in the given jurisdiction, providing a corresponding indication of the given cell tower.

11. A computer-readable storage medium for storing computer-executable instructions which when executed cause a computing device to perform a method for generating a list of allowed cell towers for a given jurisdiction to be used in a system for performing a wager using a mobile phone, the method comprising:
obtaining for each given cell tower of a plurality of cell towers an indication of the given cell tower and corresponding geographic coordinates of the given cell tower;
obtaining an indication of a size of an uncertainty zone;
obtaining a list of a plurality of geographic coordinates defining a border between two jurisdictions;
determining for each given cell tower of the plurality of cell towers if the given cell tower is in the uncertainty zone using the corresponding geographic coordinates of the given cell tower, the indication of the size of the uncertainty zone and the list of a plurality of geographic coordinates defining the border between the two jurisdictions and; if the given cell tower is not in the uncertainty zone,
determining if the given cell tower is in the given jurisdiction; and
if the given cell tower is in the given jurisdiction, providing a corresponding indication of the given cell tower.

12. The method as claimed in claim 10, wherein the geographic coordinates comprise longitude and latitude coordinates.

13. A system for performing a wager using a mobile phone, the system comprising:
a display device;
a central processing unit;
a first communication port operatively connected to the mobile phone;
a second communication port operatively connected to a unit providing an identification of a cell tower used by the mobile phone;
a memory comprising a database for storing a list of allowed cell towers and an application for performing a wager, the application for performing a wager comprising:
instructions for receiving via the first communication port a request for performing a wager sent by a user using the mobile phone, the request for performing a wager comprising data associated with the wager to perform;
instructions for obtaining via the second communication port an identification of a cell tower receiving the request for performing a wager via the communication port;
instructions for determining if the user of the mobile phone is allowed to perform the wager, the determining comprising checking if the identification of the cell tower receiving the request for performing the wager matches one of a list of allowed cell towers and checking if the user is registered;
instructions for performing the purchase if the identification of a cell tower receiving the request for performing a wager matches is in the list of allowed cell towers and if the user is registered.

14. A computer-readable storage medium for storing computer-executable instructions which when executed cause a computing device to perform a method for performing a wager using a mobile phone, the method comprising:
receiving a request for performing a wager sent using the mobile phone; obtaining an identification of a cell tower receiving the request for performing a wager;
determining if the user of the mobile phone is allowed to purchase the lottery ticket, the determining comprising checking if the identification of the cell tower receiving the request for performing a wager matches one of a list of allowed cell towers and;
checking if the user is registered and performing the wager if the identification of a cell tower receiving the request for performing a wager matches one of a list of allowed cell towers and if the user is registered.

15. The method as claimed in claim 2, wherein the user is not registered, further comprising inviting the user to register.

16. The method as claimed in claim 2, wherein the identification of a cell tower comprises longitude and latitude coordinates of the cell tower, further wherein the checking if the identification of a cell tower receiving the request for performing a wager matches one of a list of allowed cell towers is performed by comparing the longitude and latitude coordinates of the cell tower receiving the request for performing a wager with acceptable coordinates.

17. The method as claimed in claim 5, wherein the identification of a cell tower comprises longitude and latitude coordinates of the cell tower, further wherein the checking if the identification of a cell tower receiving the request for performing a wager matches one of a list of allowed cell towers is performed by comparing the longitude and latitude coordinates of the cell tower receiving the request for performing a wager with acceptable coordinates.

18. The method as claimed in claim 2, wherein the obtaining of an identification of a cell tower receiving the request for performing the wager comprises providing a number corresponding to the mobile generating the phone request for performing a wager to a geolocalization server and receiving from the geolocalization server the identification of a cell tower.

19. The method as claimed in claim 3, wherein the obtaining of an identification of a cell tower receiving the request for performing the wager comprises providing a number corresponding to the mobile generating the phone request for performing a wager to a geolocalization server and receiving from the geolocalization server the identification of a cell tower.

20. The method as claimed in claim 7, wherein the obtaining of an identification of a cell tower receiving the request for performing the wager comprises providing a number corresponding to the mobile generating the phone request for performing a wager to a geolocalization server and receiving from the geolocalization server the identification of a cell tower.
